(19) United States
(12) Patent Application Publication
(10) Pub. No.: US 2007/0193087 A1
(43) Pub. Date: Aug. 23, 2007

(54) Exhibition can

(76) Inventor: Yuan Chin Chen, Taipei Hsien (TW)

Correspondence Address: Yuan Chin Chen, 235 Chung-Ho, Box 8-24, Taipei, TW

(21) Appl. No.: 11/319,294

(22) Filed: Dec. 29, 2005

(51) Int. Cl. G09F 11/30

(52) U.S. Cl. 40/513

(57) ABSTRACT

The exhibition can comprises a bottom wall; a lateral wall extended from the bottom wall to form a receiving chamber with an opening facing upwards; the lateral wall including a lower wall portion enclosing a portion of the receiving chamber and an upper wall portion enclosing an upper portion of the receiving chamber for viewing the upper portion of the receiving chamber; an exhibition object; an exhibition object installed upon the bearing seat; a bearing seat installed upon the expandable object; a lower side of the bearing seat having at least one through hole for draining water; an expandable object installed in the receiving chamber; and a display plate installed adjacent the lateral wall and is between the expandable object and the bearing seat; the display plate being connected to the bearing seat; and an outer surface of the display plate having a pattern.

### FIELD OF THE INVENTION

The present invention relates to cans, and in particular to an exhibition can, wherein the exhibition can of the present invention is deformed with the expandable object so that a display plate is pushed upwards from the lower portion of a receiving chamber to the upper portion of the receiving chamber so that the pattern on the lower portion is displayed and the exhibition object exposes out of a receiving chamber.

### BACKGROUND OF THE INVENTION

Exhibition cans are frequently used in the current life so as to present a beautiful outlook to the living environment. Generally, plants or flowers are cultivated in the exhibition cans which provide the effect of decoration and cleaning air indoors. Thereby it is often that the exhibition cans are used as gifts.

However this kind of product has finite function and is not preferred in transformation. Thereby the outlook is dull. Thus there is an eager demand for a novel design which can improve the defect in the prior art.

### SUMMARY OF THE INVENTION

Accordingly, the primary object of the present invention is to provide an exhibition can, wherein the exhibition can of the present invention is deformed with the expandable object so that the display plate is pushed upwards from the lower portion of the receiving chamber to the upper portion of the receiving chamber so that the pattern is displayed and the exhibition object exposes out of the receiving chamber.

To achieve above objects, the present invention provides an exhibition can. The exhibition. can comprises a bottom wall; a lateral wall extended from the bottom wall to form a receiving chamber with an opening facing upwards; the lateral wall including a lower wall portion enclosing a portion of the receiving chamber and an upper wall portion enclosing an upper portion of the receiving chamber for viewing the upper portion of the receiving chamber; an exhibition object; an exhibition object installed upon the bearing seat; a bearing seat installed upon the expandable object; a lower side of the bearing seat having at least one through hole for draining water; an expandable object installed in the receiving chamber; and a display plate installed adjacent the lateral wall and is between the expandable object and the bearing seat; the display plate being connected to the bearing seat; an outer surface of the display plate having a pattern.

The various objects and advantages of the present invention will be more readily understood from the following detailed description when read in conjunction with the appended drawing.

### BRIEF DESCRIPTION OF THE DRAWINGS

FIG. 1 is a perspective view of the exhibition can of the present invention.

FIG. 2 is a schematic cross sectional view showing the initial state of the expandable object of the present invention.

FIG. 3 is a schematic cross sectional view showing the expanding state of the expandable object of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

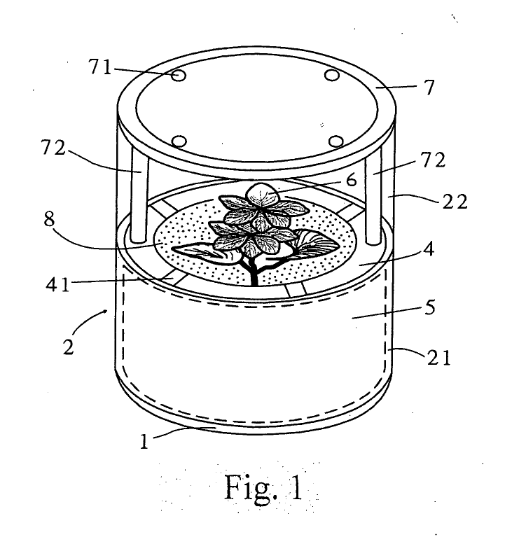

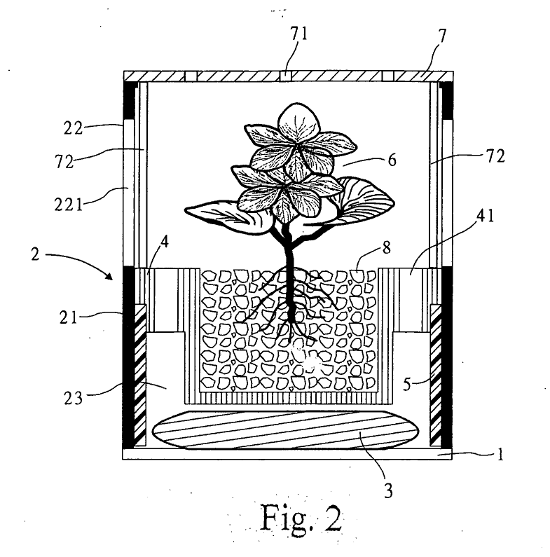

Referring to FIGS. 1 and 2, the exhibition can of t he present invention is illustrated. The present invention has the following elements.

A bottom wall 1 is included.

A lateral wall 2 extends from the bottom wall 1 so as to form a receiving chamber 23 with an opening facing upwards. The lateral wall 2 includes a lower wall portion 21 enclosing a portion of the receiving chamber 23 and an upper wall portion 22 enclosing an upper portion of the receiving chamber 23 for viewing the upper portion of the receiving chamber 23. The lower wall portion 21 is non-transparent and has patterns at a surface-thereof (not shown) for shielding the lower portion. The upper wall portion 22 has a transparent window 221 for viewing the receiving chamber 23.

An exhibition object 6 is a plant.

An exhibition object 6 is installed upon the bearing seat 4.

A bearing seat 4 is installed upon the expandable object 3. The bearing seat 4 is filled with earth or cultivation medium 8 for supplying nutrient to. the exhibition object 6. A lower side of the bearing seat 4 has at least one through hole 41 for draining water. In the present invention, the exhibition object 6 and bearing seat 4 are not confined to the above-mentioned structure. For example, the exhibition object 6 may be a doll, a decoration, a plant, a flower, etc. If the exhibition object 6 is placed upon the bearing seat 4, it is preferable that the through hole 41 is installed at the edge of the bearing seat 4.

A top cover 7 is capable of sealing the opening of the receiving chamber 23. In the present embodiment, the top cover 7 is formed with a plurality of holes 71 so that air is communicated to the external of the receiving chamber 23. A lower side of the top cover 7 is formed with a plurality of supporting units 72 which can be removed with the top cover 7. One end of each supporting unit 72 is in contact with an edge of the upper side of the bearing seat 4 so that the bearing seat 4 is firmly secured to the exhibition object 6. Thereby when the exhibition can is transferred, the exhibition object 6 will not fall down or destroyed or displayed.

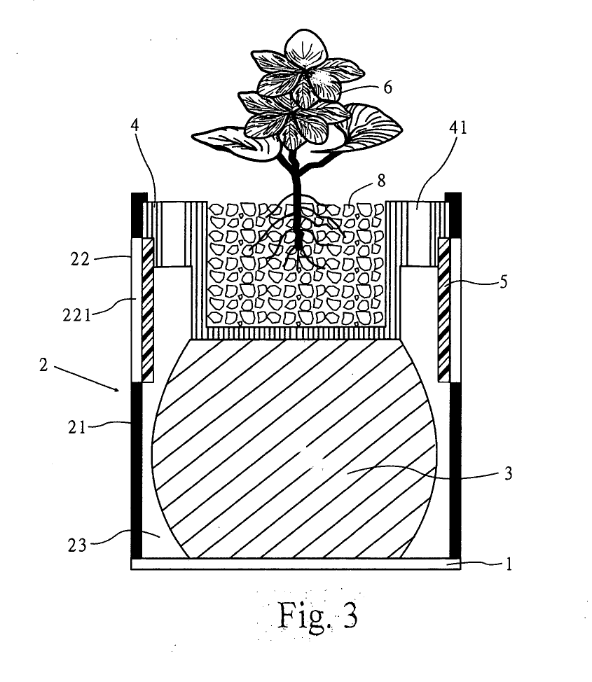

An expandable object 3 is installed in the receiving chamber 23. The expandable object 3 may be high molecular water absorbing resin for absorbing water so as to expand from the state shown in FIG. 2 to the state shown in FIG. 3. The high molecular resin is selected from one of polypropylene acid, polyvinyl alcohol, vinyl acetate, ester polyacrylamide, Polyacrylic acid, or the combination of above materials. The Polyacrylic acid is one of sodium Polyacrylic acid and potassium Polyacrylic acid.

A display plate 5 is installed adjacent the lateral wall 2 and is between the expandable object 3 and the bearing seat 4. The display plate 5 is connected to the bearing seat 4. An outer surface of the display plate 5 has a pattern including figures and textures, such as characters of “I Love You”.

Referring to FIG. 2, when the expandable object 3 is at an initial state, the display plate 5 is at the lower portion of the receiving chamber 23 so that the pattern is shielded. When the top cover 7 is removed and water is filled from the through holes 41 of the bearing seat 4, the expandable object 3 will expand to have a state illustrated in FIG. 3. The bearing seat 4 and the display plate 5 will be pushed upwards with the expansion of the expandable object 3. Then the display plate 5 is moved to the upper portion of the receiving chamber 23 so that the pattern is displayed and the exhibition object 6 protrudes out of the lateral wall 2.

Therefore, the exhibition can of the present invention is deformed with the expandable object 3 so that the display plate 5 is pushed upwards from the lower portion of the receiving chamber 23 to the upper portion of the receiving chamber 23 so that the pattern is displayed and the exhibition object exposes out of the receiving chamber 23.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An exhibition can comprising:
a bottom wall;
a lateral wall extended from the bottom wall to form a receiving chamber with an opening facing upwards; the lateral wall including a lower wall portion enclosing a lower portion of the receiving chamber and an upper wall portion enclosing an upper portion of the receiving chamber for viewing the upper portion of the receiving chamber;
an exhibition object;
an exhibition object installed upon the bearing seat;
a bearing seat installed upon the expandable object; a lower side of-the bearing seat having at least one through hole for draining water;
an expandable object installed in the receiving chamber; and
a display plate installed adjacent the lateral wall and between the expandable object and the bearing seat; the display plate being connected to the bearing seat; and an outer surface of the display plate having a pattern.

2. The exhibition can as claimed in claim 1, wherein the expandable object is high molecular water absorbing resin for absorbing water.

3. The exhibition can as claimed in claim 2, wherein the high molecular resin is selected from one of polypropylene acid, polyvinyl alcohol, vinyl acetate, ester polyacrylamide, polyacrylic acid, and the combination of above materials, and the polyacrylic acid is one of sodium polyacrylic acid and potassium polyacrylic acid.

4. The exhibition can as claimed in claim. 1, wherein the exhibition object is plant and the bearing seat filled with earth or cultivation medium for supplying nutrient to the exhibition object.

5. The exhibition can as claimed in claim 1, wherein the exhibition object is a decoration.

6. The exhibition can as claimed in claim 1, wherein the pattern is a drawing or textures.

7. The exhibition can as claimed in claim 1, further comprising a top cover is capable of sealing the opening of the receiving chamber.

8. The exhibition can as claimed in claim 1, wherein the top cover is formed with a plurality of holes so that air is communicated to the external of the receiving chamber.

9. The exhibition can as claimed in claim 1, wherein a lower side of the top cover is formed with a plurality of supporting units which can be removed with the top cover.

10. The exhibition can as claimed in claim 1, wherein the lower wall portion is non-transparent and has patterns at a surface thereof for shielding the lower portion; the upper wall portion has a transparent window for viewing the receiving chamber.
